(19) United States
(12) Patent Application Publication
(10) Pub. No.: US 2015/0017624 A1
(43) Pub. Date: Jan. 15, 2015

(54) Molecular Modeling Device

(71) Applicant: Nick Drapela, Corvallis, OR (US)

(72) Inventor: Nick Drapela, Corvallis, OR (US)

(73) Assignee: KINETIC MODELS, LLC, Corvallis, OR (US)

(21) Appl. No.: 13/940,730

(22) Filed: Jul. 12, 2013

(51) Int. Cl. G09B 23/26

(52) U.S. Cl. CPC G09B 23/26
USPC 434/278

(57) ABSTRACT

A molecular modeling device that allows for the transformation of atoms in a tetrahedral bonding arrangement around a spherical central atom to a trigonal planar bonding arrangement, without the need for disassembly and reassembly and with using the same bonds, is disclosed herein. The present invention also provides visual representations of the empty, unhybridized p-orbital on a central atom. The present invention allows users to observe a transformation between sp2 and sp3 hybridizations of an atom. The molecular modeling device may be used in education, pharmaceutical, industrial, and other applications for improved conceptualization of the geometries and angles between atomic bonds.

### FIELD OF THE INVENTION

The present invention relates to molecular modeling devices, and more specifically, to such devices which represent molecular bond geometry.

### BACKGROUND OF THE INVENTION

Molecular ball-and-stick models are well known within the art. Chemists, students, and enthusiasts use ball-and-stick models to aid in the understanding of complex molecular structures. These models are comprised of color-coded ball units simulating different molecules and are held together by rod-like sticks. These sticks can be made from a plurality of materials such as, but not limited to, wood, plastic, or metallic springs. The stick is removably placed into bored-out holes on the molecular balls, creating a simulated molecular bond.

Generally, the amount of bonding holes on the ball represents the total number of possible intermolecular bonds available to a certain atom. Hydrogen, being the most primary of elements, may only bond with one other element, and as such, the corresponding hydrogen ball molecule will only possess one bonding hole.

Molecular geometry is known within the art. Due to intramolecular forces, atoms tend not to be fixed in space with respect to other atoms during chemical reactions. The attraction and repulsion of these particles force the molecule to change shape, bend, or otherwise rehybridize. Adding additional atoms to the structure will further alter the overall shape of the complete molecule. These mutations can be very hard to comprehend and it stands to reason that a visual representation of the shape of a molecule will aid in the understanding of molecular interaction.

Current modeling systems can only offer static geometries, as these units possess fixed, drilled out holes. This makes it difficult to visualize how and why certain molecules behave the way they do. The overall transformation from reactant to product also remains very difficult to conceptualize as the user must disassemble the current structure in order to depict the final, molecular product.

When considering chemical reactions, atomic orbitals must also be considered. Current ball-and-stick models show only which orbitals are present within the complete structure. This leaves the user with a visually unknown set of orbitals, and as such, may lead to a misunderstanding of potential reactions and molecular geometry.

Within the art, it could be said there lies a need for a ball-and-stick type kit which visually presents the rehybridization of atomic orbitals without needing to disassemble or reassemble the model. The art also presents a need for a model kit which easily shows transition states on the way to a chemical product.

Molecular models are kits of atoms and bonds which may be constructed to form models of any number of molecules. They are used extensively in education as required materials in undergraduate curriculum for Organic Chemistry and in graduate research by grad students and professors. Molecular models are also used in the pharmaceutical and industrial world. They typically consist of brightly colored plastic atoms and some type of bonds. Their primary use is to be able to visually consider and analyze the three-dimensional structure of molecules for various purposes. These models, once made, are static. They do not move. They are rigid. The atoms have holes at certain angles in them where the bonds are inserted and these angles are static. This idea of the molecular model kit has remained essentially unchanged for many decades, but they have at least one major shortcoming.

Real atoms rehybridize as they undergo chemical reactions. That is to say they alter not only the number of bonds with which they attach to other atoms, but the angles between these bonds move. These geometries are very difficult to describe for both the fixed bonds and the bonds that rearrange. The difficulty in conceptualizing these bonds is one reason scientists have resorted to models for their depiction.

The present invention meets these needs by providing the user with a molecular model kit which allows the user to visually ascertain rehybridization of atomic orbitals as well as depicting unhybridized orbitals that may be present within the molecule.

### BRIEF SUMMARY OF THE INVENTION

The present invention provides a molecular modeling device that allows for the transformation of atoms in a tetrahedral bonding arrangement with fixed 109.5 degree angles around a spherical central atom to another final tetrahedral geometry then back to the original geometry, or to a trigonal planar bonding arrangement with fixed 120 degree angles around a spherical central atom. The present invention also provides a representation of the empty, unhybridized p-orbital on a central, sp2 hybrid atom. Put another way, the present invention allows for the rehybridization of an sp3 hybrid atom into an sp2 hybrid atom, and back to an sp3 hybrid atom.

Embodiments of the present invention provide a molecular modeling device that contains atoms which rehybridize. The atoms of these embodiments can undergo transformation between sp3 hybrid atoms and sp2 hybrid atoms with no required disassembly or reassembly and with using the same bonds.

Embodiments of the present invention allow the mechanism of transformation to be observed. These embodiments allow students, teachers, and researchers to see vital transition states during transformation. These transition states are exceedingly important in studying chemical kinetics, chemical mechanisms, stereochemistry, sterics, and many other fundamental chemistry topics.

Embodiments of the present invention show the unhybridized p-orbitals in sp2 hybrid atoms. These orbitals are very important mechanistically and to study and predict the nature of these substrates and the products of their reactions.

Embodiments of the present invention transform into sp3 hybrid orbitals without disassembly and reassembly whereas current molecular models require either disassembly and reassembly, or do not provide for this hybridization at all.

Embodiments of the present invention provide many other benefits over the prior art including, but not limited to, the ability to realistically show: an aromatic bond; the angle of approach for nucleophilic attack on sp2 carbons; representation of carbocations and radicals; and nitrogen inversion

In accordance with the embodiments described above, the present invention provides a molecular modeling device that allows for visual representations of transformation and rehybridization events. The molecular modeling device has several movable components that, when taken together, form the entire modeling device.

One component of the modeling device is a spherical shell comprised of a lower and an upper half The spherical shell has a design and internal construction that allow the other components of the modeling device, a center rod and three rotating arms, to extend through, or be rotatably affixed to the spherical shell.

One exemplary embodiment of the present invention provides a molecular modeling device with a center rod that extends through a spherical shell that represents a central atom. The spherical shell has three openings spaced equidistance around its circumference through which rotating arms extend and rotate through degrees of arc. The rotating arms represent the bonding arrangement of other atoms and provide a visual depiction of bonding geometries and orientation before, during, and after transformation or hybridization. The center rod controls the movement of the rotating arms through mechanical attachments within the spherical shell. When the center rod is moved, catches mounted on the ends of the rotating arms contact with pivot points on the center rod and rotate accordingly.

The preceding brief description is intended to merely outline some functions and advantages of the present invention. The following disclosure will set forth other functions and advantages of the present invention along with novel features that distinguish the present invention from the prior art. It is to be understood that the following disclosure is by no means intended to limit the scope of the present invention or any of its embodiments. It is also to be understood that the accompanying illustrations are presented for descriptive purposes only and similarly are not intended to limit the scope of present invention or any of its embodiments. The following disclosure and accompanying illustrations may describe various features of novelty that characterize the invention. The invention does not reside any particular feature when taken in the singular, but in the combination of features as described herein.

### BRIEF DESCRIPTION OF THE SEVERAL VIEWS OF THE IMAGE(S)

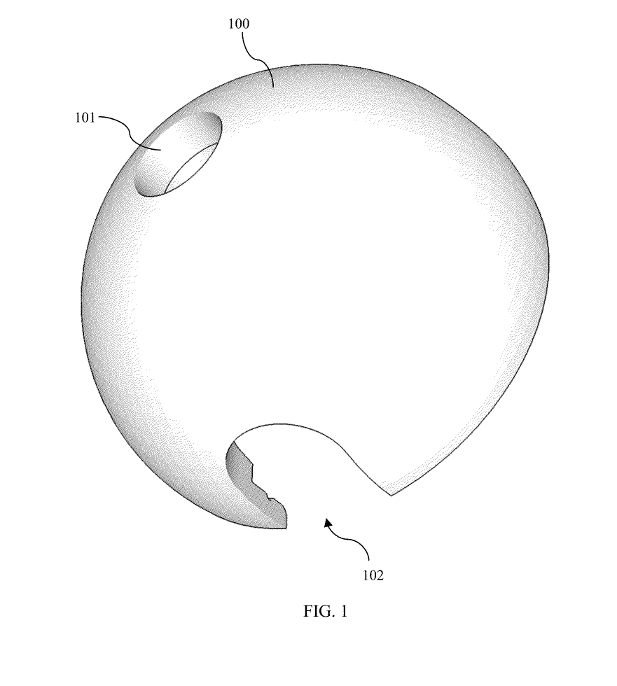

FIG. 1 is an exterior isometric view of a lower shell as according to one embodiment of the present invention;

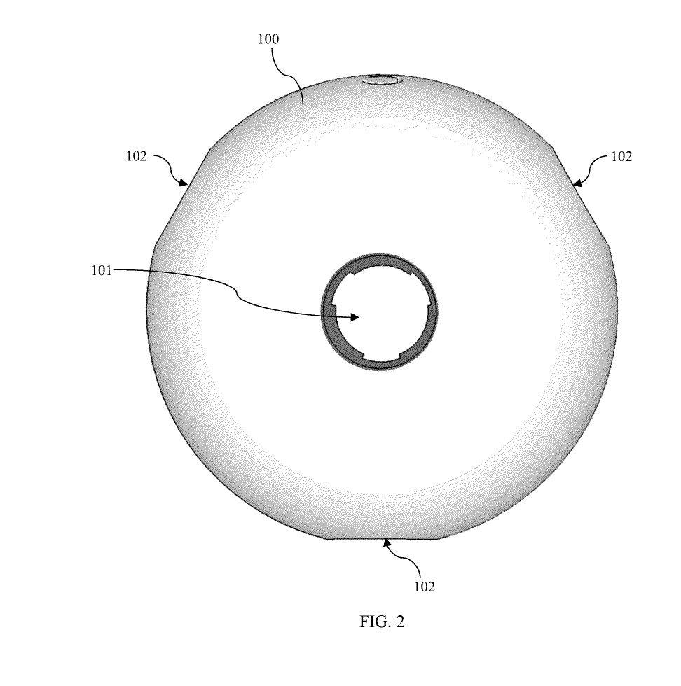

FIG. 2 is an exterior top view of a lower shell as according to one embodiment of the present invention;

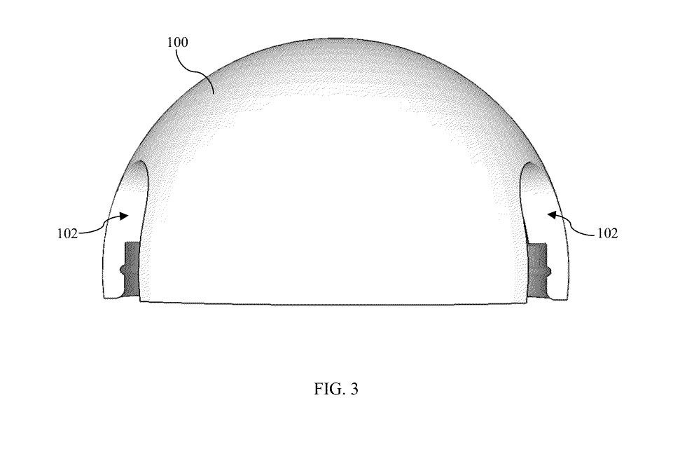

FIG. 3 is an exterior side view of a lower shell as according to one embodiment of the present invention;

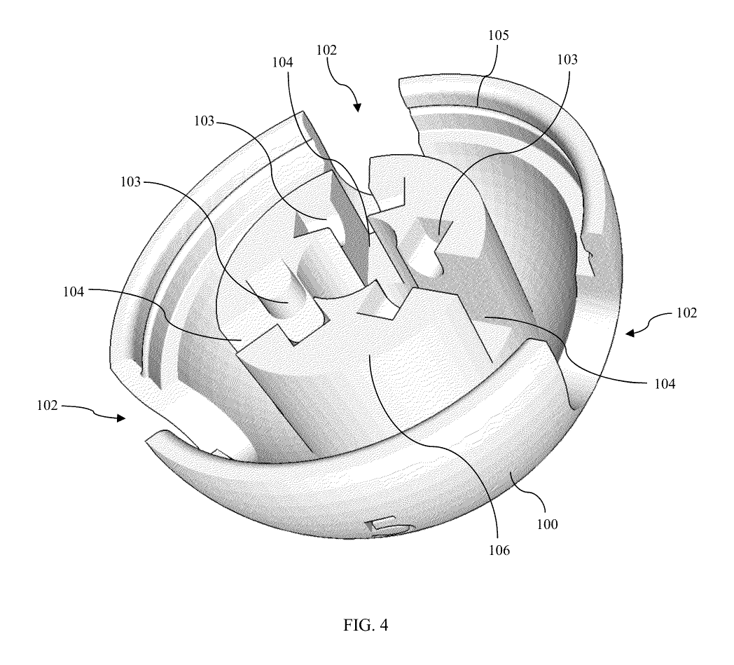

FIG. 4 is an interior isometric view of a lower shell as according to one embodiment of the present invention;

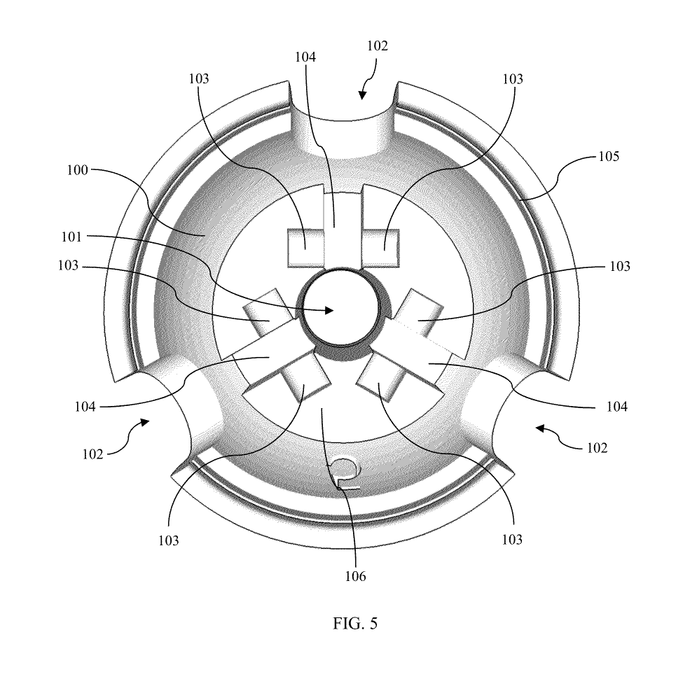

FIG. 5 is an interior top view of a lower shell as according to one embodiment of the present invention;

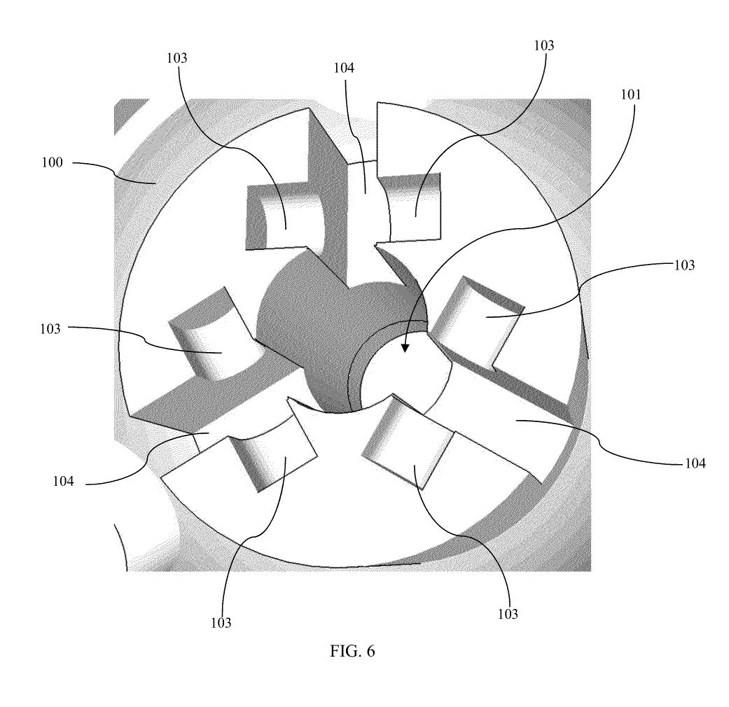

FIG. 6 is an isometric view of the hub assembly of a lower shell as according to one embodiment of the present invention;

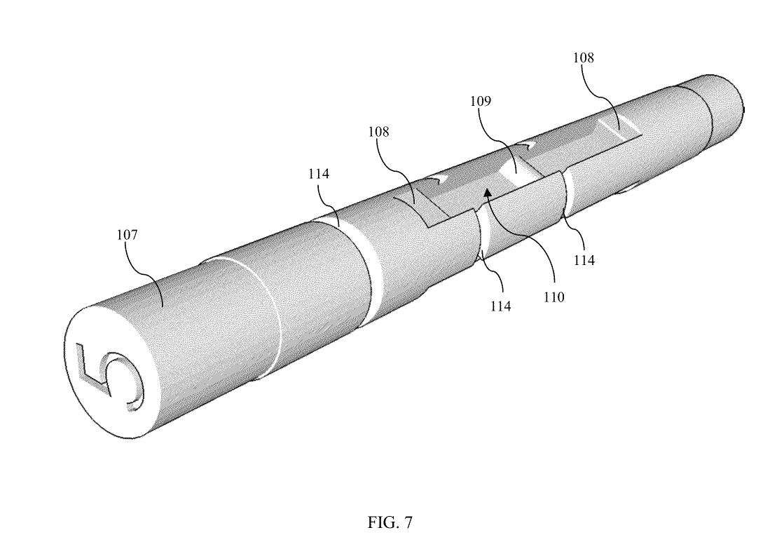

FIG. 7 is an isometric view of a center rod as according to one embodiment of the present invention;

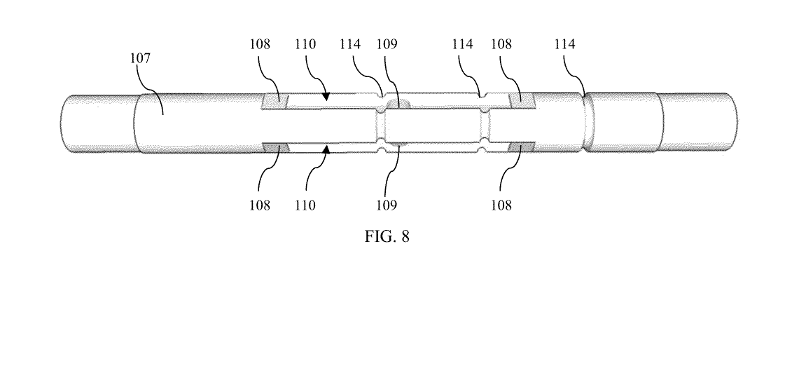

FIG. 8 is a top view of a center rod as according to one embodiment of the present invention;

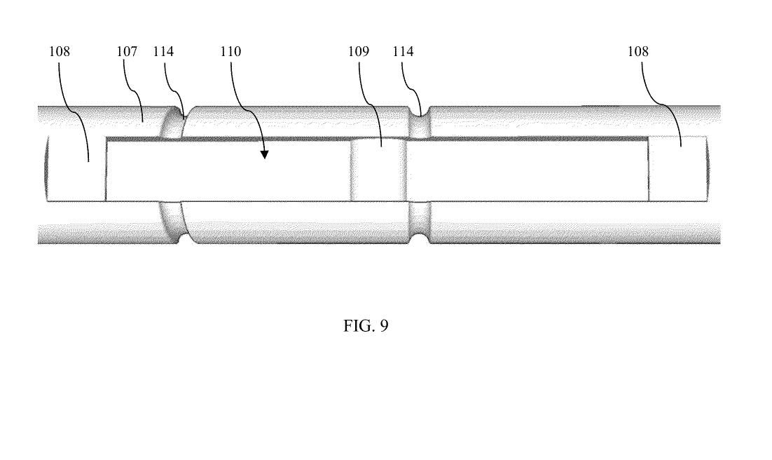

FIG. 9 is a detailed top view of a slide trough in the center rod as according to one embodiment of the present invention;

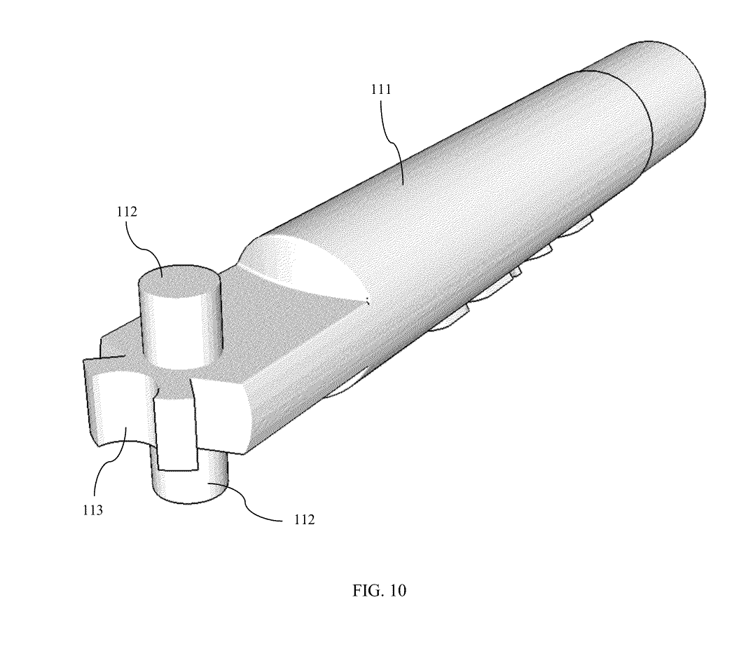

FIG. 10 is an isometric view of a rotating arm as according to one embodiment of the present invention;

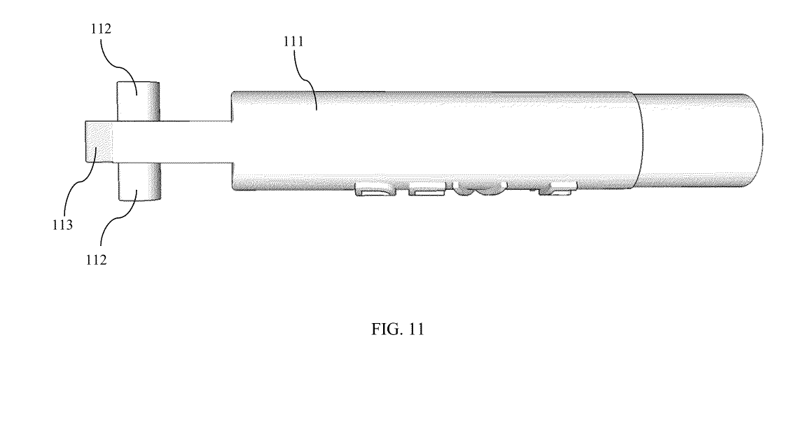

FIG. 11 is a side view of a rotating arm as according to one embodiment of the present invention;

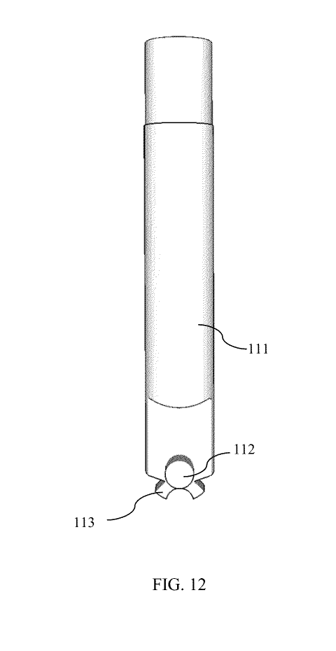

FIG. 12 is a top view of a rotating arm as according to one embodiment of the present invention;

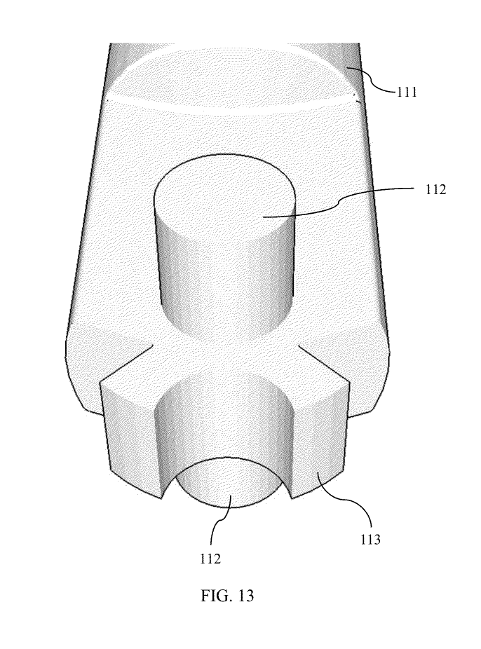

FIG. 13 is a detailed elevated front view of an end of a rotating arm as according to one embodiment of the present invention;

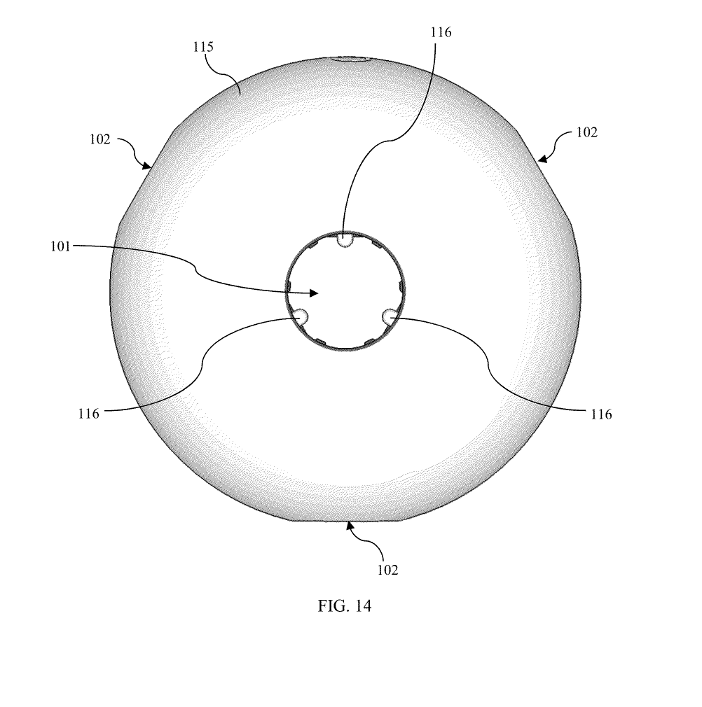

FIG. 14 is an exterior top view of an upper shell as according to one embodiment of the present invention;

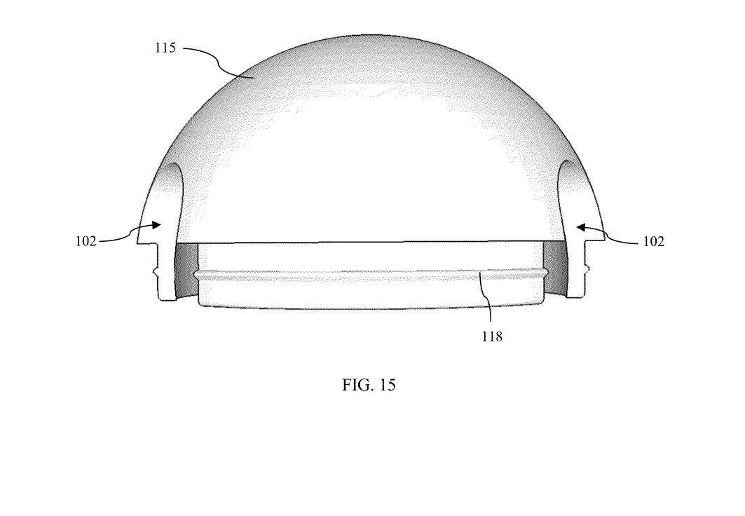

FIG. 15 is an exterior side view of an upper shell as according to one embodiment of the present invention;

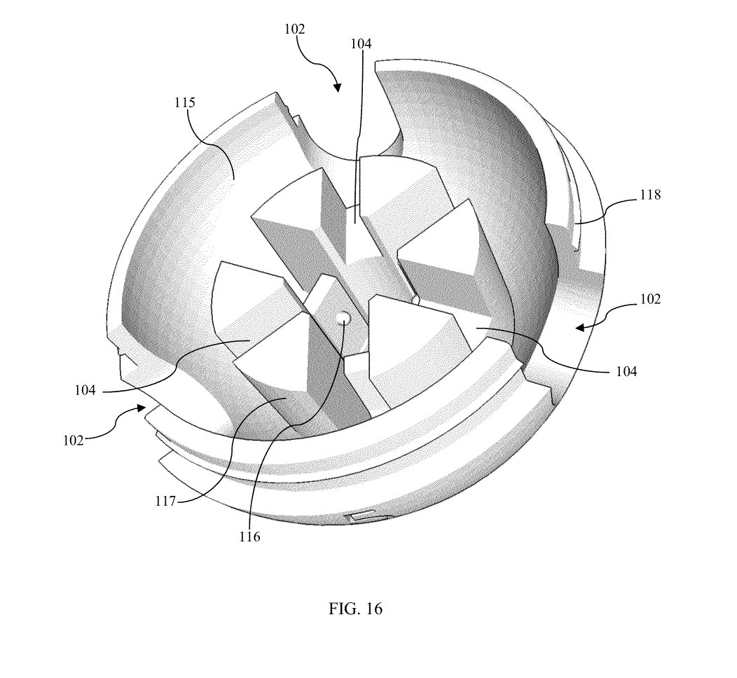

FIG. 16 is an interior isometric view of an upper shell as according to one embodiment of the present invention;

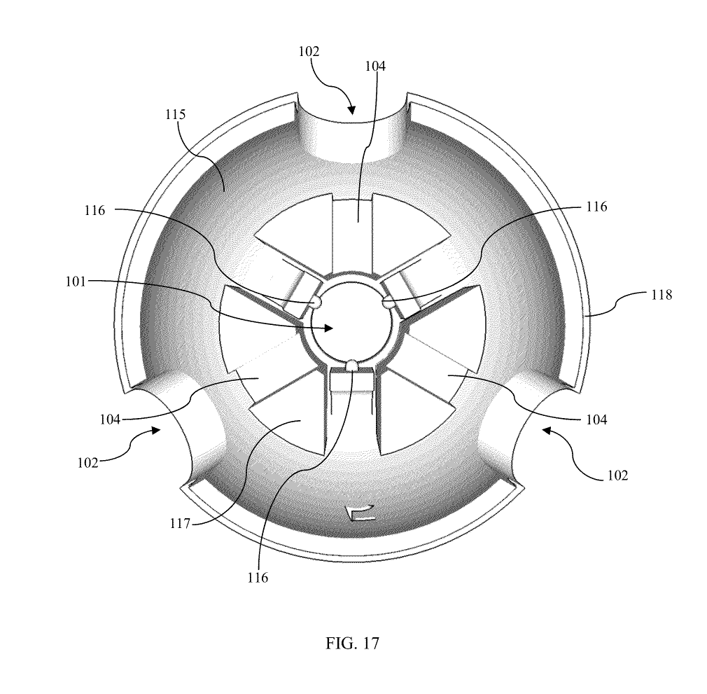

FIG. 17 is an interior top view of an upper shell as according to one embodiment of the present invention;

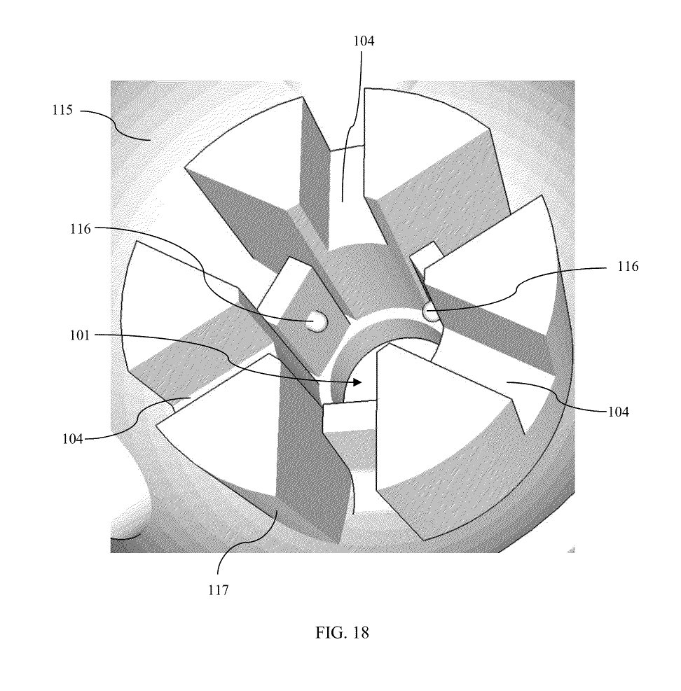

FIG. 18 is an isometric view of the hub assembly of an upper shell as according to one embodiment of the present invention;

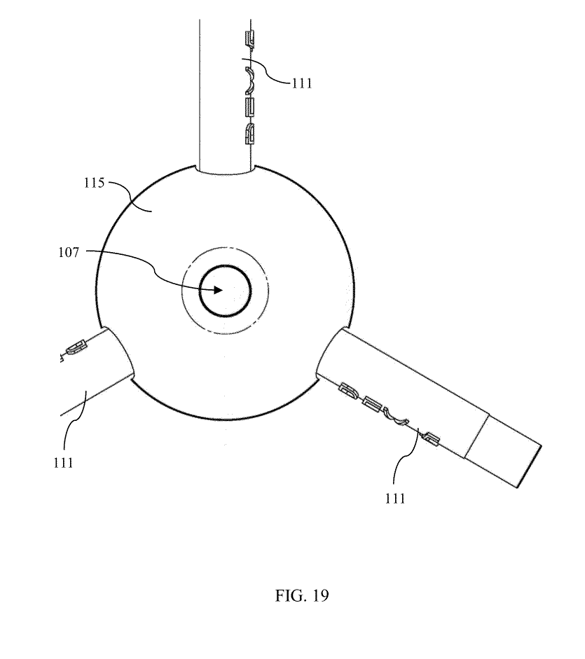

FIG. 19 is a view of a molecular modeling device in a non-transformed configuration as according to one embodiment of the present invention;

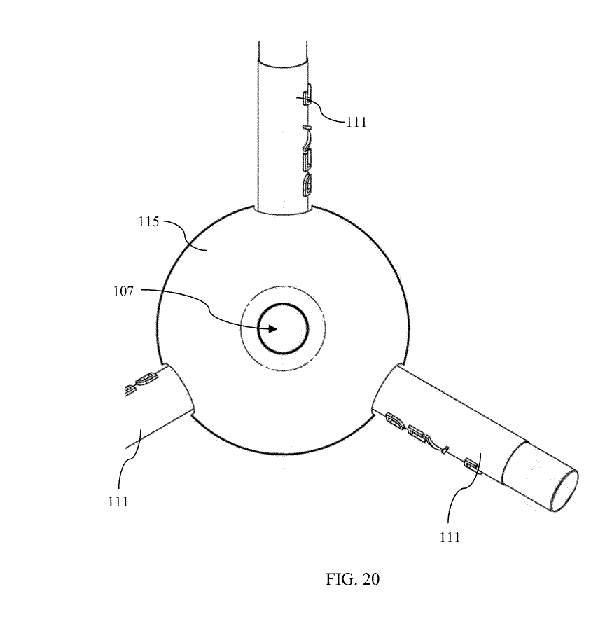

FIG. 20 is a view of a molecular modeling device in a transformed configuration as according to one embodiment of the present invention;

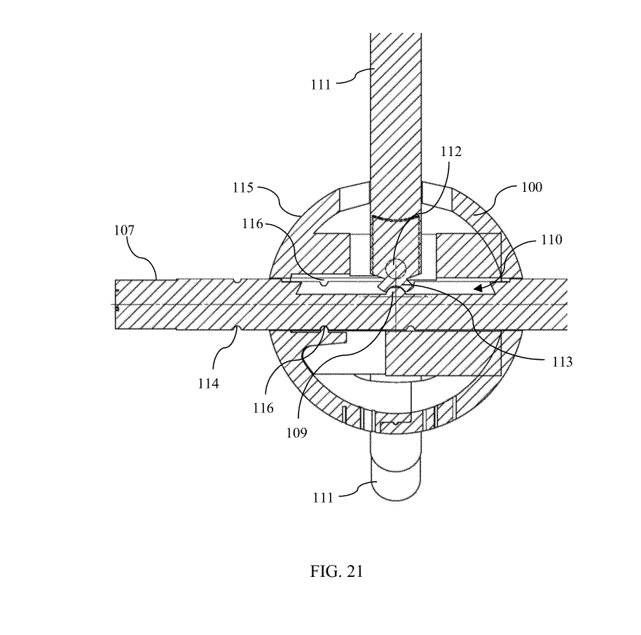

FIG. 21 is a schematic view of a molecular modeling device in a non-transformed configuration as according to one embodiment of the present invention; and

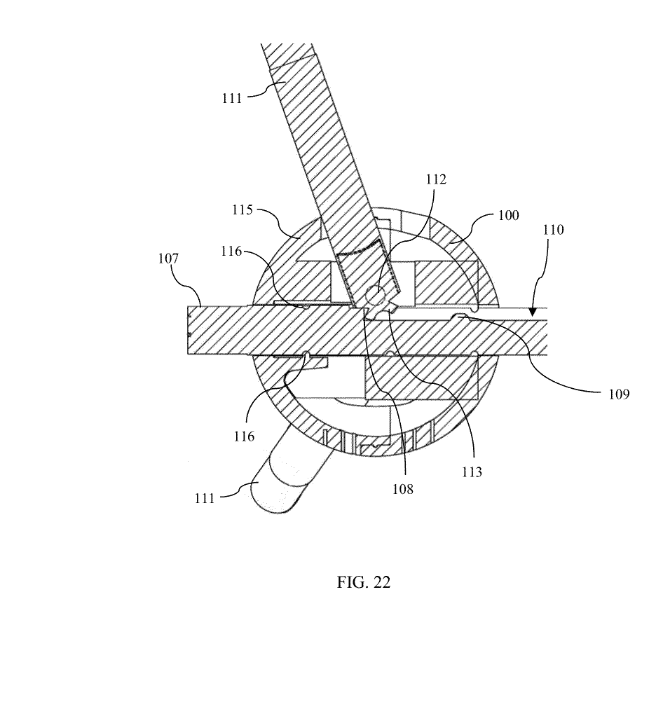

FIG. 22 is a schematic view of a molecular modeling device in a transformed configuration as according to one embodiment of the present invention.

### DETAILED DESCRIPTION OF THE INVENTION

In the following detailed description, reference is made to the accompanying images that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by appended claims, appropriately interpreted, along with the full range of equivalents to which the claims are entitled.

Further, the purpose of the Abstract herein is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application nor is it intended to be limiting as to the scope of the invention in any way.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention”, “alternative embodiment(s)”, and “exemplary embodiment(s)” do not require that all embodiments of the apparatus include the discussed feature, advantage or mode of operation. The following descriptions of the preferred embodiments are merely exemplary in nature and is in no way intended to limit the invention, its application, or use.

For the purpose of clarity, all like elements will have the same numbering and designations in each of the images. The terms “molecular modeling device”, “modeling device”, “molecular model”, “model”, “present invention”, and “invention” may be used interchangeably. In addition to the functions, features, components, and abilities of the apparatus already discussed in this specification, the molecular modeling device may also have, but not be limited to, the following features contained within the description set forth herein.

Several preferred embodiments of the molecular modeling device are discussed in this section. However, the invention is not limited to these embodiments. A molecular modeling device, as according to the present invention, is any molecular model that allows for the transformation of atoms in a tetrahedral bonding arrangement, with fixed, 109.5 degree angles around a spherical, central atom, to a trigonal planar bonding arrangement, with fixed, 120 degree angles around a spherical, central atom. Certain embodiments of the present invention also allow for representation of the empty, unhybridized p-orbital on an atom. Other embodiments of the present invention provide a molecular model that allows for the rehybridization of an sp3 hybrid atom to an sp2 hybrid atom. Embodiments of the molecular modeling device can be used for various purposes to help users visualize the three-dimensional structure of atoms before and after rehybridization.

Referring now to FIGS. 1-3 that will be discussed together, there are shown exterior views of a lower shell (100) as according to one embodiment of the present invention. The lower shell (100) is shaped as one-half of a sphere and, when combined with an upper shell (FIGS. 14-22 (115)), represents the central atom of the molecular modeling device. The lower shell (100) has several openings (101, 102) that provide passage for various components through the shell.

A circular center rod opening (101) located at the apex of the lower shell (100) allows for a center rod (FIGS. 7-9, 19-22 (107)) to pass through the center of the lower shell (100) and upper shell (FIGS. 14-22 (115)) when the shell halves are combined. The center rod (FIGS. 7-9, 19-22 (107)) provides the mechanical means to transform the molecular modeling device between bonding arrangements and will be discussed in further detail below.

Three rotating arm openings (102) are spaced equidistance around the base of the lower shell (100) that allow for rotating arms (FIGS. 10-13, 19-22 (111)) to extend outward from the center of the lower shell (100). The rotating arm openings (102) are roughly shaped as elongated circles and allow the rotating arms (FIGS. 10-13, 19-22 (111)) to rotate during transformations of the molecular modeling device. The rotating arms (FIGS. 10-13, 19-22 (111)) provide the visual representation of the bonding geometries and will be discussed in further detail below.

Referring now to FIGS. 4-6 that will be discussed together, there are shown interior views of a lower shell (100) as according to one embodiment of the present invention. The interior of the lower shell (100) has a lower shell hub (106) to which the three rotating arms (FIGS. 10-13, 19-22 (111)) are affixed. The lower shell hub (106) has three rotating arm axle housings (103) that are shaped to house and secure rotating arm axles (FIGS. 10-13, 21-22 (112)) while still allowing the rotating arms (FIGS. 10-13, 19-22 (111)) to rotate. The lower shell hub (106) has three rotating arm passages (104) that are shaped to prevent lateral movement of the rotating arms (FIGS. 10-13, 19-22 (111)), but allow the arms (FIGS. 10-13, 19-22 (111)) to rotate vertically. The lower shell hub (106) also has the center rod opening (101) extending through the middle of the hub (106).

A lower shell mating groove (105) is formed along the bottom edge of the lower shell (100). The lower shell mating groove (105) receives the upper shell mating ridge (FIGS. 15-17 (118)) and forms a snap-fit connection with the upper shell mating ridge (FIGS. 15-17 (118)) when the lower shell (100) and the upper shell (FIGS. 14-22 (115)) are combined.

In these figures, the interior of the three rotating arm openings (102) can be seen. The rotating arm openings (102) are aligned with the rotating arm passages (104) so that the rotating arms (FIGS. 10-13, 19-22 (111)) can extend through the lower shell (100). When the molecular model is assembled, the centerline of each rotating arm (FIGS. 10-13, 19-22 (111)), its corresponding rotating arm passage (104), and its rotating arm opening (102) are congruent. Furthermore, the three rotating arms (FIGS. 10-13, 19-22 (111)), their corresponding rotating arm passages (104), and their rotating arm openings (102) are aligned equiangular from a common point that is located in the center of the center rod opening (101).

Referring now to FIGS. 7-9 that will be discussed together, there is shown a center rod (107) as according to one embodiment of the present invention. The center rod (107) is cylindrical and has three rotating arm slide troughs (110) in which rotating arm transition catches (FIGS. 10-13, 21-22 (113)) slide when the center rod (107) is manipulated. At each end of the rotating arm slide troughs (110) are rotating arm stops (108) that contact the rotating arm transition catches (FIGS. 10-13, 21-22 (113)) and hold the rotating arms ((FIGS. 10-13, 19-22 (111)) in a desired configuration.

Center rod pivot points (109) are located along the rotating arm slide troughs (110) that cause the rotating arms ((FIGS. 10-13, 19-22 (111)) to rotate through degrees of arc when they come in contact with the rotating arm transition catches (FIGS. 10-13, 21-22 (113)). The center rod pivot points (109) are located at the same position in each rotating arm slide trough (110) so that the rotating arms rotating arms ((FIGS. 10-13, 19-22 (111)) move uniformly when the center rod (107) is manipulated.

Retention grooves (114) are located along the exterior of the center rod (107). Retention pins (FIGS. 14, 16-18, 21-22 (116)) located in the upper shell hub (FIGS. 16-18 (117)) fit into the retention grooves (114). The retention pins (FIGS. 14, 16-18, 21-22 (116)) hold the center rod (107) in a desired transformation or rehybridization position including partial transformation or hybridization positions. By holding the center rod (107) in partial transformation or rehybridization positions, the present invention allows for the visualization of vital transition states.

Referring now to FIGS. 10-13 that will be discussed together, there is shown a rotating arm (111) as according to one embodiment of the present invention. The present invention consists of three rotating arms (111) that are spaced equidistance from each other around the model. Each rotating arm (111) has a rotating arm axle (112) that fits into the rotating arm axle housings (FIGS. 4-6 (103)) of the lower shell hub (FIGS. 4-6 (106)). The rotating arm axle (112) allows the rotating arm (111) to rotate during hybridization or transformation events. The rotating arms (111) are able to rotate through degrees of arc including, but not limited to, 109.5 degrees when modeling tetrahedral bonding arrangements and 120 degrees when modeling trigonal planar bonding arrangements. By rotating through these degrees of arc, the rotating arms also allow for the modeling of sp3 hybrid atoms as they rehybridize to sp2 hybrid atoms. The transition states during rehybridization or transformation are observable due to the rotating action of the rotation arms (111).

Each rotating arm (111) has a rotating arm transition catch (113) at one end. The rotating arm transition catch (113) fits into the rotating arm slide trough (FIGS. 7-9, 21-22 (110)) on the center rod (FIGS. 7-9, 19-22 (107)). The rotating arm transition catch (113) catches on the center rod pivot point (FIGS. 7-9, 21-22 (109)) when the center rod (FIGS. 7-9, 19-22 (107)) is manipulated. The mechanical action of the rotating arm transition catch (113) catching on the center rod pivot point (FIGS. 7-9, 21-22 (109)) causes the rotating arm (111) to rotate when the center rod is manipulated. The rotating speed of the rotating arms (111) depends on how quickly the center rod (FIGS. 7-9, 19-22 (107)) is manipulated. Controlling the speed of rotation is particularly useful for viewing the transition states between different atomic configurations.

Referring now to FIGS. 14-15 that will be discussed together, there are shown exterior views of an upper shell (115) as according to one embodiment of the present invention. The upper shell (115) is shaped as one-half of a sphere and, when combined with the lower shell (FIGS. 1-6 (100)), represents the central atom of the molecular modeling device. The upper shell (115) has several openings (101, 102) that house various components of the present invention.

A circular center rod opening (101) is located at the apex of the upper shell (115) that allows for a center rod (FIGS. 7-9, 19-22 (107)) to pass through the center of the upper shell (115) and lower shell (FIGS. 1-6 (100)) when the shell halves are combined. The center rod (FIGS. 7-9, 19-22 (107)) provides the mechanical means to transform the molecular modeling device between bonding arrangements.

Three rotating arm openings (102) are spaced equidistance around the base of the upper shell (115) that allow for rotating arms (FIGS. 10-13, 19-22 (111)) to extend outward from the center of the upper shell (115). The rotating arm openings (102) are roughly elongated circles in shape and allow the rotating arms (FIGS. 10-13, 19-22 (111)) to rotate during transformations of the molecular modeling device. The rotating arm openings (102) of the upper shell (115) correspond in position, and line up with, the rotating arm openings (102) located on the lower shell (FIGS. 1-6 (100)) when the shell halves are combined.

An upper shell mating ridge (118) is formed along the bottom exterior edge of the upper shell (115). The upper shell mating ridge (118) fits into the lower shell mating groove (FIGS. 4-5, (105)) and forms a snap-fit connection with the lower shell mating groove (FIGS. 4-5, (105)) when the upper shell (115) and the lower shell lower shell (FIGS. 1-6 (100)) are combined.

Referring now to FIGS. 16-18 that will be discussed together, there are shown interior views of an upper shell (115) as according to one embodiment of the present invention. The interior of the upper shell (115) has an upper shell hub (117) through which the three rotating arms (FIGS. 10-13, 19-22 (111)) pass. The upper shell hub (117) has three rotating arm passages (104) that are shaped to prevent lateral movement of the rotating arms (FIGS. 10-13, 19-22 (111)), but allow the arms (FIGS. 10-13, 19-22 (111)) to rotate vertically. The upper shell hub (117) also has the center rod opening (101) extending through the middle of the hub (117). Within the center rod opening (101) are retention pins (116) that fit into the retention grooves (FIGS. 7-9, 21-22 (114)) of the center rod (FIGS. 7-9, 19-22 (107)). The retention pins (116) snap into position within the retention grooves (FIGS. 7-9, 21-22 (114)) and hold the center rod (FIGS. 7-9, 19-22 (107)) in a particular position until the user manipulates the center rod (FIGS. 7-9, 19-22 (107)) into a different position.

In these figures, the interior of the three rotating arm openings (102) can be seen. The rotating arm openings (102) are aligned with the rotating arm passages (104) so that the rotating arms (FIGS. 10-13, 19-22 (111)) can extend through the upper shell (115). When the molecular model is assembled, the centerline of each rotating arm (FIGS. 10-13, 19-22 (111)), its corresponding rotating arm passage (104), and its rotating arm opening (102) are congruent. Furthermore, the three rotating arms (FIGS. 10-13, 19-22 (111)), their corresponding rotating arm passages (104), and their rotating arm openings (102) are aligned equiangular from a common point that is located in the center of the center rod opening (101).

Referring now to FIGS. 19 and 20 that will be discussed together, there are shown top-down views of a molecular modeling device in non-transformed and transformed configurations as according to one embodiment of the present invention. In FIG. 19, the rotating arms (111) are shown extending perpendicularly outward from the upper shell (115). The center rod (107) is depicted as extending directly toward the viewer. When a user manipulates the center rod (107) , the rotating arms (111) rotate and, as seen in FIG. 20, are oriented toward the viewer. The rotation of the rotating arms (111) causes their geometry to uniformly change thereby modeling the behavioral characteristics of atoms and their bonds during hybridization or transformation.

Referring now to FIGS. 21 and 22 that will be discussed together, there are shown schematic views of a molecular modeling device in non-transformed and transformed configurations as according to one embodiment of the present invention. FIG. 21 correlates to FIG. 19 in showing a molecular configuration with the rotating arms (111) extending perpendicularly outward from the center sphere which is comprised of the upper shell (115) and the lower shell (100). The rotating arm transition catches (113) are engaged with the center rod pivot points (109) thereby holding the rotating arms (111) in their perpendicular orientation. The center rod (107) is held in position by the retention pins (116) that are inserted into the retention grooves (114).

FIG. 22 correlates to FIG. 20 in showing a molecular configuration with the rotating arms (111) no longer in a perpendicular orientation. The rotating arms (111) have rotated on their rotating arm axles (112) due to the manipulation of the center rod (107). The manipulation of the center rod (107) caused the rotating arm transition catches (113) to disengage from the center rod pivot points (109) and slide along the rotating arm slide troughs (110). The rotating arm transition catches (113) have come to rest against the rotating arm stops (108). The rotating arms (111) are now held in the depicted orientation by the force of the rotating arm stops (108) pressing against the rotating arm transition catches (113). In FIG. 22, the center rod (107) is held in position by the retention pins (116) fitting into retention grooves (114) that are farther along the center rod (107).

As set forth in this description and the attached images, an improved molecular modeling device has been developed that improves upon conventional modeling devices. The various embodiments of the improved molecular modeling device described herein can be used in a wide variety of applications.

The preceding exemplary embodiments are not intended to be limiting, but are merely illustrative for the possible uses of the molecular modeling device.

Although certain example apparatus and articles of manufacture have been described herein, the scope of coverage of this patent is not limited thereto. On the contrary, this patent covers all apparatus and articles of manufacture fairly falling within the scope of the invention either literally or under the doctrine of equivalents.

With respect to the above description then, it is to be realized that the optimum dimensional relationships for the parts of the molecular modeling device, to include variations in size, materials, shape, form, function and the manner of operation, and use, are deemed readily apparent and obvious to one skilled in the art, and all equivalent relationships to those illustrated in the images and described in the specification are intended to be encompassed by the molecular modeling device.

Directional terms such as “front”, “back”, “in”, “out”, “downward”, “upper”, “lower”, “top”, “bottom”, “lateral”, “vertical” and the like have been used in the description. These terms are applicable to the embodiments shown and described in conjunction with the images. These terms are merely used for the purpose of description in connection with the images and do not necessarily apply to the positions in which the molecular modeling device may be used.

Therefore, the foregoing is considered as illustrative only of the principles of the molecular modeling device. Further, since numerous modifications and changes will readily occur to those skilled in the art, it is not desired to limit the molecular modeling device to the exact construction and operation shown and described, and accordingly, all suitable modifications and equivalents may be resorted to, falling within the scope of the molecular modeling device. While the above description describes various embodiments of the present invention, it will be clear that the present invention may be otherwise easily adapted to fit any configuration where a molecular modeling device is desired or required.

As various changes could be made in the above constructions without departing from the scope of the invention, it is intended that all matter contained in the above description or shown in the accompanying images shall be interpreted as illustrative and not in a limiting sense.

What is claimed is:

1. An apparatus comprising:
a means for representing a central atom; a means for representing bonds; a means for transforming the arrangement of the central atom and the means for representing bonds between a tetrahedral bonding arrangement and a trigonal planar bonding arrangement;
and a means for holding the central atom and the means for representing bonds in the tetrahedral bonding arrangement, the trigonal planar bonding arrangement, and in transition states between the two bonding arrangements.

2. The apparatus of claim 1, wherein the means for representing a central atom is a sphere from which the means for representing bonds extends.

3. The apparatus of claim 2, wherein the sphere consists of an upper shell, a lower shell, and openings for the means for representing bonds to pass through.

4. The apparatus of claim 1, wherein the means for representing bonds are three rotating arms.

5. The apparatus of claim 1, wherein the means for transforming the arrangement of the central atom and the means for representing bonds is a central rod.

6. The apparatus of claim 5, wherein the means for holding the central atom and the means for representing bonds in the tetrahedral bonding arrangement, the trigonal planar bonding arrangement, and in transition states between the two bonding arrangements are retention pins located within the means for representing the central atom that fit into retention grooves that are located along the central rod.

7. The apparatus of claim 1, wherein the transformation between the tetrahedral bonding arrangement and the trigonal planar bonding arrangement does not require disassembly or reassembly of the apparatus.

8. A molecular modeling device comprising:
a sphere that represents a central atom; rotating arms that represent bonds that extend from the sphere and are configured in an equiangular orientation from each other; a central rod that passes through the sphere and allows users to alter the geometry of the rotating arms; wherein the sphere and the rotating arms are capable of representing a tetrahedral bonding arrangement, a trigonal planar bonding arrangement, and transition states between the two bonding arrangements without the need to disassemble or reassembly the molecular modeling device.

9. The apparatus of claim 8, wherein the sphere is comprised of an upper shell and a lower shell.

10. The apparatus of claim 8, wherein the central rod has retention grooves along its length that hold the central rod in desired configurations.

11. The apparatus of claim 10 wherein retention pins within the sphere fit into place within the retention grooves of the central rod to hold the central rod in desired configurations.

12. The apparatus of claim 9, wherein the upper shell and the lower shell contain hubs that secure the rotating arms and allow them to rotate.

13. The apparatus of claim 9, wherein the upper shell and the lower shell have rotating rod openings that allow the rotating rods to extend through the sphere when the two shell halves are combined.

14. A device for modeling the bonds between atoms during rehybridization or transformation comprising:
a plurality of rotating rods that represent the bonds between atoms, a central rod that alters the geometry of the rotating rods thereby changing visual representations of a molecule being modeled, a mechanical connection between the rotating rods and the center rod that causes the rotating rods to rotate when the center rod moves, a sphere that represents a central atom, a hub located within the sphere to which the ends of the rotating rods are secured, axles on each of the rotating rods that allow the rotating rods to rotate in unison when the center rod is moved, and a series of mechanical attachments that allow the center rod to lock into place thereby causing the device to represent final or transitional molecular states.

15. The device of claim 14, wherein the plurality of rotating rods is three.

16. The device of claim 14, wherein the central rod has troughs containing pivot points in which rotating catches located on the ends of the rotating rods slide until the rotating catches come into contact with the pivot points.

17. The device of claim 14, wherein the device is capable transforming between representations of molecules in a tetrahedral bonding arrangement and a trigonal planar bonding arrangement without the need to disassemble or reassemble the device.

18. The device of claim 14, wherein the hub further comprises rotating arm axle housings that allow the axles on the rotating arms to rotate.

19. The device of claim 14, wherein a center rod opening extends through the middle of the sphere and allows the center rod to connect with the rotating arms.

20. The device of claim 14, wherein the series of mechanical attachments is comprised of retention ridges on the center rod and retention pins within the hub.
